(19) United States
(12) Patent Application Publication
(10) Pub. No.: US 2007/0110075 A1
(43) Pub. Date: May 17, 2007

(54) MEDIA INDEPENDENT HANDOVER APPLICATION SERVER FOR FACILITATING SEAMLESS INTEGRATION OF MULTI-TECHNOLOGY NETWORKS

(75) Inventor: Ulises Olvera-Hernandez, Kirkland (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/555,318

(22) Filed: Nov. 1, 2006

Related U.S. Application Data
(60) Provisional application No. 60/733,705, filed on Nov. 4, 2005.

(51) Int. Cl. H04L 12/56

(52) U.S. Cl. 370/395.52

(57) ABSTRACT

A media independent handover (MIH) application server which facilitates seamless integration of multi-technology networks. The MIH application server includes a higher layer transport unit for interfacing with at least one dual mode terminal, a layer 2 (L2) transport unit for interfacing with the dual mode terminal via a first access network, (e.g., IEEE 802.21, Ethernet and the like), and a session initiation protocol (SIP) interface for interfacing with the dual mode terminal via a second access network, (e.g., a Third Generation Partnership Project (3GPP) network). The MIH application server facilitates seamless integration of Internet protocol (IP) functions of the dual mode terminal via the higher layer transport unit, facilitates seamless integration of IEEE 802 functions of the dual mode terminal via the L2 transport unit, and supports SIP signaling between the MIH application server and the dual mode terminal via the second access network.

### CROSS REFERENCE TO RELATED APPLICATION

This application claims the benefit of U.S. Provisional Application No. 60/733,705 filed Nov. 4, 2005, which is incorporated by reference as if fully set forth.

### FIELD OF INVENTION

The present invention is related to wireless communication systems. More particularly, the present invention is related to implementing media independent handover (MIH) services, (e.g., handover commands, event notification and network information services), by incorporating Internet protocol (IP) multimedia subsystems (IMS) within Third Generation Partnership Project (3GPP) networks.

### BACKGROUND

The IEEE 802.21 standard defines mechanisms and procedures that aid in the execution and management of inter-system handovers. Under IEEE 802.21, three main services can be accessed by mobility management applications in order to aid in the management of handover operations and system discovery and system selection. These services include an event service, an information service and a command service. These services do not depend on each other and, as a result, may be delivered independently.

Currently, however there are no interfaces or mechanisms that describe how IEEE 802.21 services may interact with existing mobility management and handover functionality already defined within relevant 3GPP specifications. There are no procedures or functionality to integrate IEEE 802.21 services within 3GPP unless existing mobility management mechanisms and handover procedures are modified. Therefore, an MIH application server that is capable integrating MIH Services in a 3GPP based network is required.

### SUMMARY

The present invention is related to an MIH application server which facilitates seamless integration of multi-technology networks. The MIH application server includes a higher layer transport unit for interfacing with at least one dual mode terminal, a layer 2 (L2) transport unit for interfacing with the dual mode terminal via a first access network, (e.g., IEEE 802.21, Ethernet and the like), and a session initiation protocol (SIP) interface for interfacing with the dual mode terminal via a second access network, (e.g., a 3GPP network). The MIH application server facilitates seamless integration of Internet protocol (IP) functions of the dual mode terminal via the higher layer transport unit, facilitates seamless integration of IEEE 802 functions of the dual mode terminal via the L2 transport unit, and supports SIP signaling between the MIH application server and the dual mode terminal via the second access network.

The present invention provides a mechanism that allows IEEE 802.21 servers to communicate with 3GPP systems. The present invention defines a network architecture that supports IEEE 802.21 based intersystem handovers using an MIH server as an application server or part of an application server handling mobility or call control which interfaces with 3GPP systems.

In the 3GPP specification TS 23.228 IP multimedia subsystem, stage 2 (release 7), the concept of an application server is defined. The present invention takes advantage of some application server properties, such as the possibility to reside within the user's home network or in a third party location. The application server may then present two main interfaces: one interface supporting the IEEE 802.21 protocol, (or a subset of it), and a standard session initiation protocol (SIP) with IMS extensions. The present invention may be incorporated into 3GPP networks by becoming an IMS application server.

The present invention is applicable to IEEE 802 technologies, wireless local area network (WLAN) baseline air interface standards, IEEE 802.11 baseline, IEEE 802.11a orthogonal frequency division multiplexing (OFDM) 5GHz WLAN, IEEE 802.1 lb high rate direct sequence spread spectrum (HR-DSSS) 2.4GHz WLAN, IEEE 802.11g OFDM 2.4GHz WLAN, IEEE 802.11j OFDM 10 MHz option WLAN, IEEE 802.11n high-throughput (HT) WLAN, IEEE 802.16 broadband wireless access systems, IEEE 802.21 MIH, WLAN standards supplements to extend operation for particular scenarios, cellular standards such as 3GPP or 3GPP2 , and other standardized or proprietary wireless technologies similar to IEEE 802 WLANs, such as IEEE 802.15 Bluetooth, and HIPERLAN/2.

### BRIEF DESCRIPTION OF THE DRAWINGS

The foregoing summary, as well as the following detailed description of the preferred embodiments of the present invention will be better understood when read with reference to the appended drawings, wherein:

FIG. 1 is a multi-technology network reference model that supports IEEE 802.xx and 3GPP capabilities of a dual mode terminal through the use of an MIH application server which is configured in accordance with the present invention;

FIG. 2 is a detailed block diagram of the MIH application server used in the multi-technology network reference model of FIG. 1; and

FIG. 3 is a detailed block diagram of an alternate configuration of the MIH application server used in the multi-technology network reference model of FIG. 1.

### DETAILED DESCRIPTION OF THE PREFERRED EMBODIMENTS

The present invention allows the introduction of MIH Services, (e.g., handover commands, event notification and network information services), by making use the IMS architecture. The IMS architecture in 3GPP facilitates the introduction of application services, by establishing a set of common rules that all applications must follow, based on SIP signaling. From this perspective, MIH may be perceived as an application server on its own right, or even as part of another application server such as the voice call continuity (VCC) application server, (e.g., consisting of domain transfer function (DTF)/call session adaptation function (CSAF) that supports the VCC application at the IMS network entity, or a mobility management entity (MME) in long term evolution (LTE)).

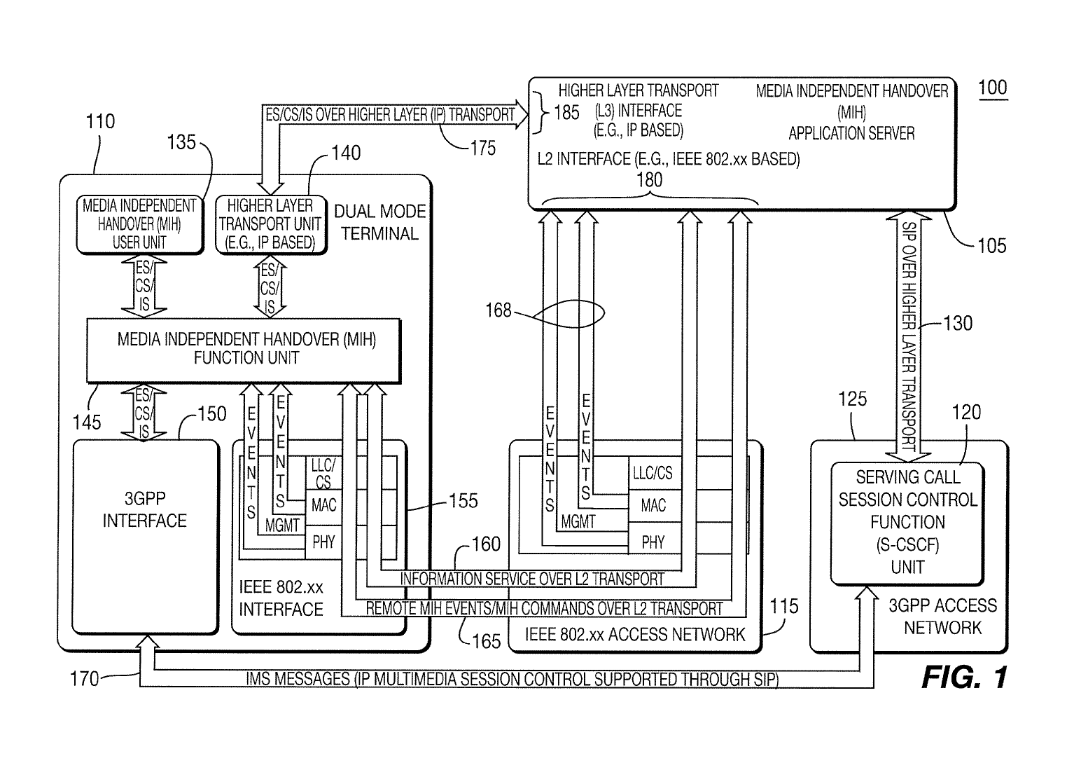

FIG. 1 is a multi-technology network reference model 100 that supports IEEE 802.xx, (e.g., IEEE 802.21), and 3GPP capabilities of a dual mode terminal 110 through the use of an MIH application server 105 which is configured in accordance with the present invention. The network reference model 100 includes an MIH application server 105, a dual mode terminal 110, an IEEE 802.xx access network 115 and an S-CSCF unit 120 which operates in a 3GPP access network 125. SIP signaling is used by the MIH application server 105 to communicate with the S-CSCF unit 120 over an SIP higher layer transport interface 130. The IEEE 802.xx access network 115 may be an IEEE 802.xx access point (AP) or an IEEE 802.xx access router (AR).

The dual mode terminal 110 includes an MIH user unit 135, a higher layer transport unit 140, an MIH function unit 145, a 3GPP interface 150 and an IEEE 802.xx interface 155.

The dual mode terminal 110 is connected to the IEEE 802.xx access network 115 via an L2 transport connection 160, over which information service is provided, and an L2 transport connection 165 over which MIH commands are provided. When the 3GPP interface 150 of the dual mode terminal 110 is connected to the 3GPP access network 125 via an IP connection 170, mobility is controlled according to the 3GPP specification.

The MIH application server 100 includes an L2 interface 180 by which information service is established via the L2 transport connection 160, MIH commands are exchanged via the L2 transport connection 165 and events are received via L2 transport connections 168. The dual mode terminal 110 exchanges IMS messages with the S-CSCF unit 120 in the 3GPP access network 125 via the IP connection 170 over which IP multimedia session control is supported through SIP. An IP connection 175 is established between the dual mode terminal 110 and the MIH application server 105 to provide a pathway for implementing an event service (ES), a command service (CS) and an information service (IS) over a higher layer (IP) transport. The dual mode terminal 110 is adaptable to multi-technology and multi-modes, (e.g., UMTS/GSM, IEEE 802.11/802.16 and the like). The dual mode terminal 110 supports IEEE 802.xx technology, (e.g., IEEE 802.21, Ethernet and the like), and SIP.

When the dual mode terminal 110 needs to switch from the 3GPP access network 125 to the IEEE 802.xx access network 115, mobility is controlled by the MIH application server 105 via the L2 interface 180, (e.g., IEEE 802.xx based), or via the L3 interface 185, (e.g., IP based).

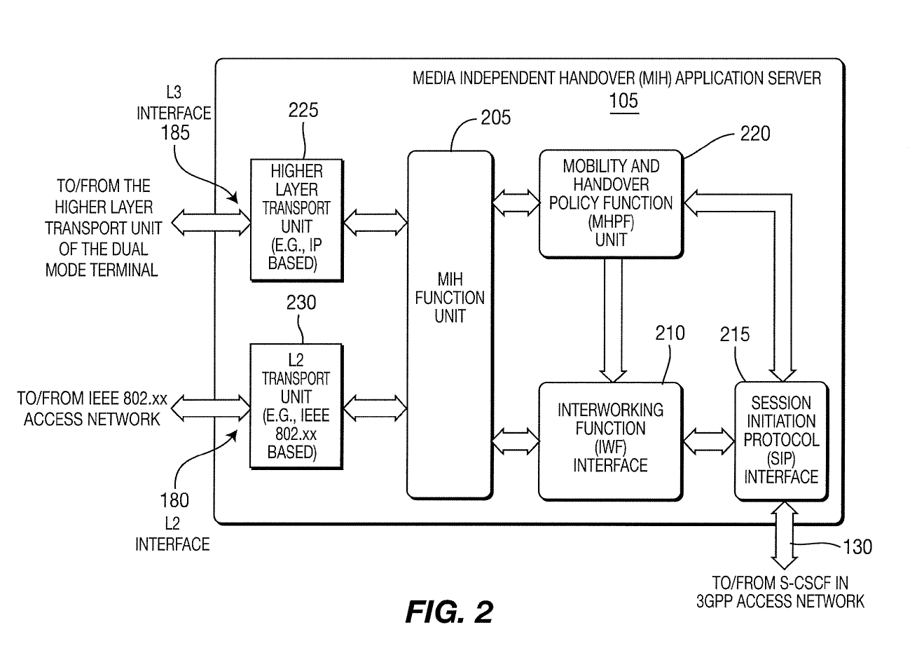

FIG. 2 shows a detailed block diagram of the MIH application server 105 used in the multi-technology network reference model 100 of FIG. 1. The MIH application server 105 includes an MIH function unit 205, an interworking function (IWF) interface 210, an SIP interface 215, a mobility and handover policy function (MHPF) unit 220, a high layer transport unit 225 and an L2 transport unit 230.

The MIH application server 105 facilitates seamless integration of IP functions to/from the dual mode terminal 110 over any IMS capable network via the higher layer transport unit 225. The MIH application server 105 facilitates seamless integration of IEEE 802.xx functions to/from the dual mode terminal 110 via an 802.xx access network 115 via the L2 transport unit 230. The MIH application server 105 also supports SIP signaling and interfaces with the S-CSCF 120 in the 3GPP access network 125 via the SIP interface 215.

The MIH function unit 205 receives handover triggers in the form of MIH events, and also receives handover messages in the form of handover command responses, (e.g., a handover complete message), via the higher layer transport unit 225 and/or the L2 transport unit 230.

The MIH function unit 205 outputs handover commands either through the higher layer transport unit 225, (e.g., over IP), or through the L2 transport unit 230, (e.g., the IEEE 802.11 management plane), in response to the MIH events and handover messages received via the higher layer transport unit 225 and/or the L2 transport unit 230. The MIH function unit 205 may also output events signaling to the MHPF unit 220, (e.g., the change of the current state of the link layer technology supporting the session). The MIH function unit 205 may also output events signaling to the IWF interface 210, (e.g., indicating the successful completion of a handover).

The IWF interface 210 interprets SIP messages received via the SIP interface 215 using predetermined logic and translates the SIP messages into MIH messages for transmission, and vice versa.

The IFW interface 210 receives events from the MIH function unit 205, SIP signaling from the SIP interface 215 and commands from the MHPF unit 220 that need to be translated into either MIH or SIP signaling. The IFW interface 210 outputs commands to the MIH function unit 205 or the SIP interface 215.

The MHPF unit 220 dynamically determines the specific behavior and mapping of SIP Messages to MIH Messages, and vice versa. The MHPF unit 220 may control handovers across heterogeneous networks supporting both IEEE 802.21 and SIP based signaling.

The MHPF unit 220 receives handover events and SIP signaling, and outputs handover commands and SIP call control signaling.

The SIP interface 215 receives commands from the MHPF unit 220 for session control purposes, and may also receive events from the MIHF unit 220 via the IWF interface 210. The SIP interface 215 outputs SIP signaling for call/session control purposes.

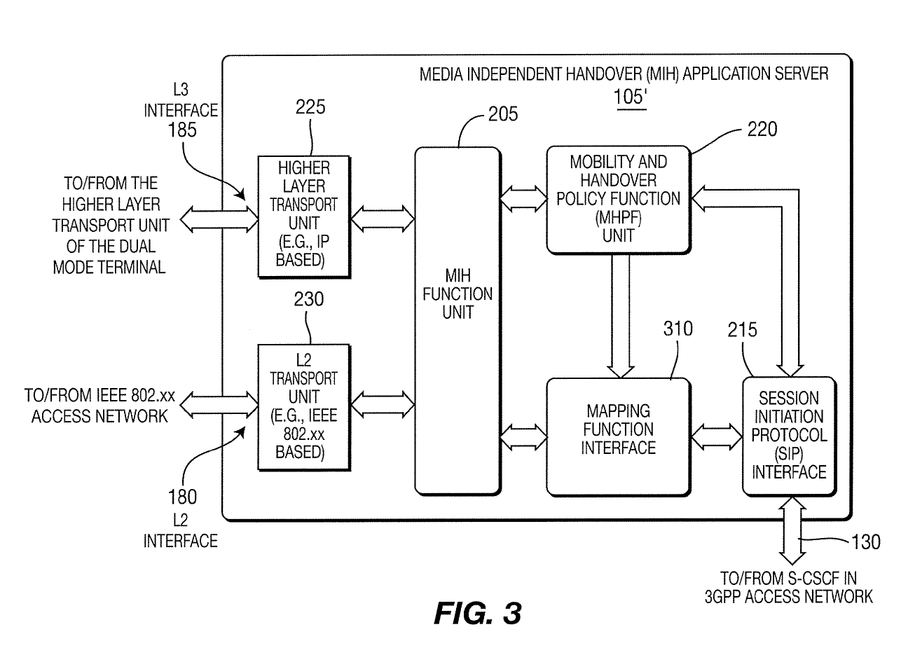

FIG. 3 shows a detailed block diagram of an alternate embodiment of an MIH application server 105′ used in the multi-technology network reference model 100 of FIG. 1. In the MIH application server 105′, a mapping function interface 310 is used in lieu of the IFW interface 210 shown in FIG. 2. The IWF interface 310 is responsible for mapping IEEE 802.xx messages and procedures into SIP signaling based on a simple translation table, without the use of any additional logic.

The MIH application server 105 integrates both IEEE 802.21 based and SIP based call control functionality for calls or sessions that are handled over a packet data network with both 3GPP and IEEE 802.xx access networks.

A practical example could be the handling of a voice over Internet Protocol using SIP as the call control mechanism. The following constitutes basic session set-up procedure and how the MIH application server 105 could handle this scenario, including mobility.

A first IMS user initiates an IMS session with a second IMS user by transmitting an SIP INVITE message to the S-CSCF unit 120 in the 3GPP access network via the IP connection 170. The SIP INVITE message is forwarded by the S-CSCF unit 120 to the SIP interface 215. The SIP interface 215 analyzes the SIP INVITE message and routes it to the second IMS user.

The second IMS user, (e.g., the called party), answers the SIP INVITE message with an SIP ACCEPT message, which is sent to the first IMS user via the MIH application server 105. The SIP ACCEPT message authorizes the establishment of a session between the first and second IMS users, thus allowing the flow of media through a media plane which supports the session. The MIU application server 105 remains in the signaling path between the first and second IMS users, such that the mobility of the session can be monitored and controlled.

Once the session is established, the first IMS user may change its serving network from the current 3GPP access network 125 to an available IEEE 802.xx access network 115, (e.g., an IEEE 802.11 access network or an Ethernet network). This is detected though an IEEE 802.xx, (e.g., IEEE 802.21), event that is routed from the dual mode terminal 110 of the first IMS user to the MIH function unit 205 within the MIH application server 105.

The MIH function unit 205 relays this message to the MHPF unit 220 which determines that a handover should be triggered towards the IEEE 802.xx network 115. The MHPF unit 220 uses IEEE 802.xx messages to trigger the handover.

When the handover has been successfully completed, a handover complete message is received at the MIH function unit 205 residing within the MIH application server 105. The handover complete message is relayed to the IWF interface 210 or the mapping function interface 310, which then translates the handover complete message into an SIP REINVITE message which is then output toward the second user via the SIP interface 215 and the 3GPP access network 125. The SIP REINVITE message indicates to the IMS second user that the first IMS user has moved to a new network.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. A media independent handover (MIH) application server for facilitating seamless integration of multi-technology networks, the MIH application server comprising:
a higher layer transport unit for interfacing with at least one dual mode terminal;
a layer 2 (L2) transport unit for interfacing with the dual mode terminal via a first access network; and
a session initiation protocol (SIP) interface for interfacing with the dual mode terminal via a second access network, wherein the MIH application server facilitates seamless integration of Internet protocol (IP) functions of the dual mode terminal via the higher layer transport unit, facilitates seamless integration of IEEE 802 functions of the dual mode terminal via the L2 transport unit, and supports SIP signaling between the MIH application server and the dual mode terminal via the second access network.

2. The MIH application server of claim 1 wherein the first network is an IEEE 802 network.

3. The MIH application server of claim 1 wherein the first access network is an Ethernet network.

4. The MIH application server of claim 1 wherein the second access network is a Third Generation Partnership Project (3GPP) network.

5. The MIH application server of claim 1 further comprising:
an MIH function unit coupled to the higher layer transport unit and the L2 transport unit for receiving handover triggers in the form of MIH events from the dual mode terminal via one of the first access network and the second access network.

6. The MIH application server of claim 1 further comprising:
an MIH function unit coupled to the higher layer transport unit and the L2 transport unit for receiving handover messages in the form of handover command responses from the dual mode terminal via one of the first access network and the second access network.

7. The MIH application server of claim 1 further comprising:
an MIH function unit coupled to the higher layer transport unit and the L2 transport unit for sending handover commands to the dual mode terminal via the higher layer transport unit and the first access network or via the L2 transport unit and the second access network.

8. The MIH application server of claim 1 further comprising:
an MIH function unit coupled to the higher layer transport unit and the L2 transport unit;
a mobility and handover policy function (MHPF) unit coupled between the MIH function unit and the SIP interface; and
an interworking function (IWF) interface coupled to the MIH function unit, the MHPF unit and the SIP interface.

9. The MIH application server of claim 8 wherein the MHPF unit receives handover events from the MIH function unit, receives SIP signaling from the SIP interface, outputs handover commands to the MIH function unit, and outputs SIP call control signaling to the SIP interface.

10. The MIH application server of claim 8 wherein the IFW interface receives events from the MIH function unit, SIP signaling from the SIP interface and commands from the MHPF unit that need to be translated into either MIH or SIP signaling.

11. The MIH application server of claim 10 wherein the IFW interface outputs commands to the MIH function unit or the SIP interface.

12. The MIH application server of claim 1 further comprising:
an MIH function unit coupled to the higher layer transport unit and the L2 transport unit;
a mobility and handover policy function (MHPF) unit coupled between the MIH function unit and the SIP interface; and
a mapping function interface coupled to the MIH function unit, the MHPF unit and the SIP interface.

13. A media independent handover (MIH) application server for facilitating seamless integration of multi-technology networks, the MIH application server comprising:
an MIH function unit for receiving handover triggers in the form of MIH events from a dual mode terminal via either a first access network or a second access network; and
a session initiation protocol (SIP) interface for interfacing with the dual mode terminal via the second access network, wherein the MIH application server facilitates seamless integration of Internet protocol (IP) and IEEE 802 functions of the dual mode terminal, and supports SIP signaling between the MIH application server and the dual mode terminal via the second access network.

14. The MIH application server of claim 13 wherein the dual mode terminal includes a first higher layer transport unit, the MIH application server further comprising:
a second higher layer transport unit coupled to the MIH function unit for interfacing with the first higher layer transport unit of the dual mode terminal; and
a layer 2 (L2) transport unit coupled to the MIH function unit for interfacing with the dual mode terminal via the first access network.

15. The MIH application server of claim 13 wherein the first access network is an IEEE 802 network.

16. The MIH application server of claim 13 wherein the first access network is an Ethernet network.

17. The MIH application server of claim 13 wherein the second access network is a Third Generation Partnership Project (3GPP) network.

18. The MIH application server of claim 13 wherein the MIH function unit receives handover triggers in the form of MIH events from the dual mode terminal via one of the first access network and the second access network.

19. The MIH application server of claim 13 wherein the MIH function unit receives handover messages in the form of handover command responses from the dual mode terminal via one of the first access network and the second access network.

20. The MIH application server of claim 13 wherein the MIH function unit sends handover commands to the dual mode terminal via one of the first access network and the second access network.

21. The MIH application server of claim 13 further comprising:
a mobility and handover policy function (MHPF) unit coupled between the MIH function unit and the SIP interface; and
an interworking function (IWF) interface coupled to the MIH function unit, the MHPF unit and the SIP interface.

22. The MIH application server of claim 21 wherein the MHPF unit receives handover events from the MIH function unit, receives SIP signaling from the SIP interface, outputs handover commands to the MIH function unit, and outputs SIP call control signaling to the SIP interface.

23. The MIH application server of claim 22 wherein the IFW interface receives events from the MIH function unit, SIP signaling from the SIP interface and commands from the MHPF unit that need to be translated into either MIH or SIP signaling.

24. The MIH application server of claim 23 wherein the IFW interface outputs commands to the MIH function unit or the SIP interface.

25. The MIH application server of claim 13 further comprising:
a mobility and handover policy function (MHPF) unit coupled between the MIH function unit and the SIP interface; and
a mapping function interface coupled to the MIH function unit, the MHPF unit and the SIP interface.
